(19) United States
(12) Patent Application Publication
(10) Pub. No.: US 2021/0002917 A1
(43) Pub. Date: Jan. 7, 2021

(54) END CAP FOR LUMBER PRODUCTS AND ASSOCIATED DEVICES, SYSTEMS, AND METHODS

(71) Applicant: Bryan Anders Bostrom, Providence, UT (US)

(72) Inventor: Bryan Anders Bostrom, Providence, UT (US)

(21) Appl. No.: 16/921,936

(22) Filed: Jul. 7, 2020

Related U.S. Application Data
(60) Provisional application No. 62/871,085, filed on Jul. 6, 2019.

(51) Int. Cl. E04H 12/22; B60B 33/00

(52) U.S. Cl. CPC E04H 12/2292; E04H 12/2269; B60B 33/0002

(57) ABSTRACT

A protective end cap for lumber products includes a body comprising a lower surface and at least three lateral walls defining an upwardly-opening cavity configured to receive an end of a rectangular piece of lumber. The body includes: an upper portion comprising a first width and a first length, and a lower portion comprising a second width and a second length. In some embodiments, the first width is smaller than the second width. In some embodiments, the first length is smaller than the second length. The body further includes a transition portion comprising a tapered surface positioned between the upper portion and the lower portion. In some embodiments, a first lateral wall defines a first through-hole in the upper portion of the body extending from an exterior surface of the first lateral wall to an interior surface of the first lateral wall.

### CROSS-REFERENCE TO RELATED APPLICATIONS

The present disclosure claims priority to and the benefit of U.S. Provisional Patent Application No. 62/871,085, filed Jul. 6, 2019, the entirety of which is hereby incorporated by reference.

### TECHNICAL FIELD

The present disclosure relates to end caps and connector devices used in construction. More specifically, the present disclosure describes devices and methods for providing protective end coverings for structures built using lumber products.

### BACKGROUND

Lumber products, such as 2×4 studs, have long been used as staples of residential construction. Furthermore, the high availability, low cost, and versatility of these lumber products makes them an attractive material for a wide range of consumer uses, including shelving, patio furniture, garage organization, and workbenches. While their simplicity allows for diverse applications, the structures made by these lumber products suffer from some drawbacks. For example, furniture, tables, and other structures built using 2×4 studs can have an unappealing unfinished look. Further, as the feet of these structures may consist of an unfinished end of a wood stud, the end grain of the stud is often placed against the ground. This makes these structures particularly susceptible to water-related damage, as the end grain of the wood can absorb even small amounts of standing water, leading to undesirable swelling, warping, rotting, or other types of damage. Further still, lumber end grain may have a high coefficient of friction when used with concrete surfaces, making them difficult to move once completed. This may be particularly problematic in the case of structures made of 2×4 studs, as they tend to be heavy and cannot be easily picked up.

### SUMMARY

The present disclosure provides protective and decorative end caps or footings for the end of a piece of dimensional lumber such as those commonly known as “2×4” and “4×4”. In some embodiments, the end cap is slid over the end of the lumber and fastened to it through the screw holes in the end cap. The end cap is made of plastic durable in a wide range of temperatures so that it remains strong in extreme seasonal conditions indoors or outdoors. The end cap protects the end-grain of the lumber or other material that a “leg” is made out of from absorbing moisture from the ground which reduces rot. The end cap also gives the leg it is attached to a wider base, making it more stable. Screw holes provide a way to effectively extend the length of the leg the end cap is attached to which will help to level or remove wobble or unevenness from the object, i.e. a shelf, in the legs that the end cap is attached to. For example, if an end cap is attached to four legs of a workbench and the bench wobbles because one leg is slightly too short, one or more legs can be raised to height inside the end cap that resolves the wobble and then fastened in those positions using screws through the screw holes. The end cap may also solve the problem of an unprotected leg, such as a 2×4 stud, from splintering and wearing as it is slid across a rough floor or surface such as concrete. The hard plastic of the end cap allows the legs the end caps are attached to slide across a rough surface more easily, and without damaging the bare legs of the object. The end cap also provides a finished look to a shelf or piece of furniture and can be made in different colors.

In some embodiments, lumber end cap devices can be positioned over the feet of structures built from lengths of common lumber products. In some embodiments, an end cap for lumber comprises a molded polymer body that includes at least three side walls and a bottom wall defining a cavity configured to receive an end of a piece of lumber. The end cap may include a lower base portion with a larger outer profile and greater thickness in the side walls to increase the surface area of the footing, thereby improving the stability of the associated structure. The end cap may further include fixation holes positioned in one or more of the side walls to provide for securing of the end cap to the lumber and/or leveling of structures built by the lumber. The end caps described in the present disclosure are configured for use with a variety of lumber products, including wood studs, boards, posts, rails, strips, or other materials that may comprise a variety of cross-sectional measurements. For example, the end cap devices can be configured for use with 2×4 studs, 2×3 studs, 4×4 posts, 1×2, 1×1, 2×2, 2×6, 2×8, or any other suitable type of lumber products.

In an exemplary embodiment, an end cap for lumber products includes: an integral body comprising a lower surface and at least three lateral walls defining an upwardly-opening cavity configured to receive an end of a rectangular piece of lumber, wherein the integral body comprises: an upper portion comprising a first width and a first length; a lower portion comprising a second width and a second length, wherein the first width is smaller than the second width and wherein the first length is smaller than the second length; and a transition portion comprising a tapered surface positioned between the upper portion and the lower portion, wherein a first lateral wall defines a first through-hole in the upper portion of the body extending from an exterior surface of the first lateral wall to an interior surface of the first lateral wall.

In some embodiments, a second lateral wall opposite the first lateral wall defines a second through-hole in the upper portion of the body extending from an exterior surface of the second lateral wall to an interior surface of the second lateral wall. In some embodiments, the end cap includes a high-friction pad positioned on the lower surface. In some embodiments, the integral body comprises a molded construction formed of at least one of nylon, polyethylene, polyvinyl, polyetheretherketone (PEEK), or Acrylonitrile butadiene styrene (ABS). In some embodiments, the end cap further includes a removable lateral wall portion configured to be removably positioned between a first lateral wall and a third lateral wall, wherein the removal lateral wall portion comprises lateral projections configured to engage respective lateral grooves in the integral body.

In another embodiment of the present disclosure, a footing configured to couple to an end of a piece of lumber includes: a cap portion comprising a plurality of walls defining a cavity configured to receive the end of the piece of lumber, wherein the cap portion comprises a lower section and an upper section, the upper section defining an opening of the cavity, and wherein the lower section comprises a first outer profile that is larger than a second outer profile of the upper section; and a roller assembly attached to a first lateral wall of the cap portion, the roller assembly comprising: a wheel; an axel; and a wheel housing coupled to the axel, wherein the roller assembly is coupled to the cap portion such that the wheel is positioned above a bottom plane of the cap portion.

In some embodiments, the roller assembly is separably attached to the first lateral wall of the cap portion, wherein the wheel housing comprises an inner surface configured to abut the lower section and the upper section of the cap portion. In some embodiments, the inner surface of the wheel housing defines a first through-hole and the first lateral wall defines a second through-hole, and wherein the roller assembly is separably attached to the first lateral wall via a fastener positioned through the first lateral wall and the inner surface. In some embodiments, the upper section of the first lateral wall defines a securing hole, and wherein the roller assembly is coupled to the first lateral wall such that access to the securing hole is unobstructed.

According to another embodiment of the present disclosure, an end cap assembly includes: a main body comprising: a first lateral wall, a second lateral wall, a third lateral wall, and a bottom wall defining a cavity, wherein each of the first lateral wall, the second lateral wall, and the third lateral wall comprise an upper portion having a first thickness, a base portion having a larger second thickness, and a tapered transition portion positioned between the upper portion and the base portion and forming a transition in thickness between the base portion and the upper portion; and a removable side wall configured to be coupled to the main body portion, wherein the removable side wall portion comprises an upper portion having the first thickness, a base portion having the second thickness, and a transition portion positioned between the base portion and the upper portion and forming a transition in thickness between the base portion and the upper portion, wherein the main body and the removable side wall portion are configured to form a tongue and groove coupling such that, when the removable side wall is coupled to the main body, the end cap assembly comprises a symmetrical cross-section.

Additional aspects, features, and advantages of the present disclosure will become apparent from the following detailed description.

### BRIEF DESCRIPTION OF THE DRAWINGS

Illustrative embodiments of the present disclosure will be described with reference to the accompanying drawings, of which:

FIG. 1A is a partially-transparent perspective view of an end cap configured to be positioned over an end of a length of lumber, according to an embodiment of the present disclosure.

FIG. 1B is a side elevation view of the end cap shown in FIG. 1A, according to an embodiment of the present disclosure.

FIG. 1C is a side elevation view of the end cap shown in FIGS. 1A and 1B, according to an embodiment of the present disclosure.

FIG. 2A is a perspective view of an end cap assembly including a roller and a removable side wall, according to an embodiment of the present disclosure.

FIG. 2B is a side elevation view of the end cap assembly shown in FIG. 2A, according to an embodiment of the present disclosure.

FIG. 3A is a top perspective view of en end cap including a shim placement plug, according to an embodiment of the present disclosure.

FIG. 3B is a bottom perspective view of the end cap shown in FIG. 3A, the end cap including gripping pads coupled to a bottom surface of the end cap, according to an embodiment of the present disclosure.

FIG. 4 is a partially-transparent perspective view of a rectangular end cap assembly with weep holes and riser features, according to an embodiment of the present disclosure.

### DETAILED DESCRIPTION

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices and methods, and any further application of the principles of the present disclosure are fully contemplated and included within the present disclosure as would normally occur to one skilled in the art to which the disclosure relates. For example, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

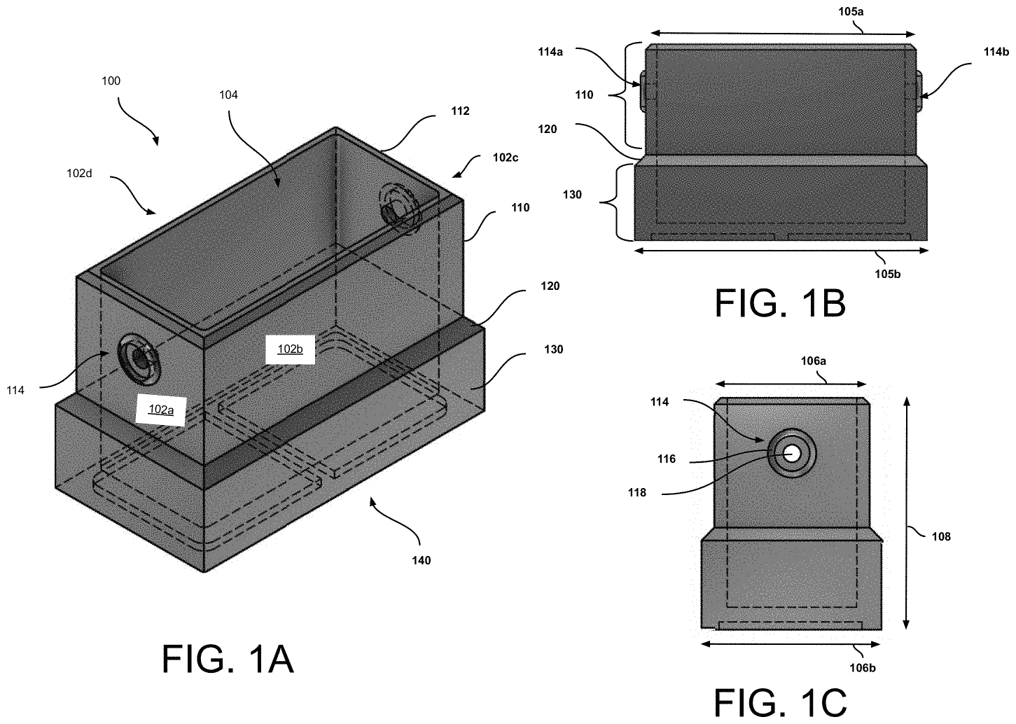

As described above, furniture and other structures built using standard lumber products suffer from a number of drawbacks, including poor aesthetic appeal and, susceptibility to water damage, and low mobility. Accordingly, the present disclosure provides end caps, end cap assemblies, and associated devices and methods for providing protective footings to lumber products and structures that address some or all of the above-mentioned deficiencies. In that regard, FIG. 1A is a perspective view of an end cap device 100 configured to provide a protective footing for lumber products, according to one embodiment of the present disclosure. The end cap 100 of the embodiment shown in FIG. 1A is sized and shaped to be positioned over an end of a common 2×4 piece of lumber. However, it will be understood that the end cap 100 could be modified for use with a number of sizes of lumber, including 2×3, 4×4, 1×2, etc. The end cap 100 shown in FIG. 1A comprises a single, integral structure that includes four side walls 102 and a bottom wall portion 140 that together define a cavity 104. Accordingly, the end cap 100 forms a partial enclosure for an end of a lumber product. In some aspects, the end cap 100 may comprise a polymer structure and may be formed using polymer molding processes, such as injection molding, rotational molding, stamping, machining, 3D printing, or any other suitable manufacturing technique. Accordingly, the end cap 100 may at least partially protect the lumber from water damage, termite damage, or other physical types of damage.

In the embodiment of FIG. 1, the end cap 10 comprises an upper portion 110, a base portion 130, and a transition portion 120 positioned between the upper portion 110 and the base portion 130. Referring to FIGS. 1A-1C, the upper portion 110 comprises a first length 105a and a first width 106a, while the base portion 130 comprises a larger, second length 105b and a larger, second width 106b. The larger second length 104b and second width 106b provide the end cap 100 with a larger footprint at the bottom while keeping a relatively smaller profile and/or more flexible covering at the upper portion 110. In some aspects, the larger footprint at the base portion 130 may improve the stability of the lumber structure to which the end cap 100 is attached, and may provide for a sleek finished aesthetic.

In some embodiments, the larger profile or footprint of the base portion 130 results from an increase in thickness in the sidewalls at the base portion 130. The sidewalls may be formed to have a flat or planar inner surface while the outer surface protrudes outward at the transition portion 120 and base portion 130. Accordingly, in an exemplary embodiment, the cavity 104 of the end cap 100 may comprise a constant, rectangular cross-sectional profile along the height 108 of the end cap 100. However, in other embodiments, the thickness of the sidewalls 102 is substantially constant from the upper portion 110 to the base portion 130, and the increase in the footprint of the base portion 130 results from the side walls 102 being formed to protrude outward. In such a configuration, the inner and outer surfaces may be substantially parallel.

The transition portion 120 is positioned between the upper portion 110 and the base portion 130. The transition portion 120 provides a taper or transition between the relatively smaller or more narrow upper portion 110 and the relatively larger or wider base portion 130. In the embodiment of FIGS. 1A-1C the transition portion 120 comprises a flat, diagonal tapered surface extending from the upper portion 110 to the base portion 130. However, in other embodiments, the transition portion 120 comprises a curved transition or bevel. In other embodiments, there is no transition portion between the upper portion 110 and the base portion 130. In still other embodiments, the sidewalls 102 are fully tapered from top to bottom, whereby the outer profile of the end cap 100 gradually increases moving downward from the top edge 112 to the bottom wall portion 140.

In the illustrated embodiment, the first sidewall 102a and the third sidewall 102c each comprise, or define, a securing hole extending through each respective sidewall 102a, 102c. The securing holes are configured to receive fasteners to secure the end cap 100 to the piece of lumber. In some aspects, the securing holes may advantageously allow for leveling adjustments of wood structures. In that regard, the end cap 100 may be configured to allow the piece of lumber to be adjusted within the end cap 100 and secured by a fastener, such as a screw or nail, at a desired elevation. For example, for a table having four legs made of 2×4 studs, four end caps 100 could be coupled to the four respective legs. Then, one or a plurality of the end caps 100 may be adjusted such that the bottom of each of the end caps 100 are level, reducing or eliminating wobble. Additionally, if the table is later moved to a location having a non-level floor, the fasteners could be removed, the end caps 100 readjusted, and fasteners replaced to compensate for the particular dimensions and shape of the floor.

Referring to FIG. 1C, in the illustrated embodiment, each of the securing holes 114 comprises a through-hole 118 and an annular protrusion 116. The annular protrusion 116 may protrude an amount equal to the length of a head portion of a screw or nail, such that the back of the screw or nail lies flush with an outer surface of the annular protrusion 116. In other embodiments, each securing hole 114 comprises a counter sink configured to receive a tapered screw head such that the back of the screw head lies flush with the outer surface of the respective side wall 102a, 102c when the screw is fully inserted and fastened to the lumber.

Referring to FIGS. 1A-1C, in the illustrated embodiment, the end cap 100 comprises a top end 112 positioned at a top portion of the sidewalls 102. The top end 112 shown in FIGS. 1A-1C comprises beveled edges, which may facilitate placement of the piece of lumber within the end cap 100 and reduce undesirable sharp edges. In some embodiments, only one of the edges of the top end 112 is beveled, such as the inner edge of the top end 112. In other embodiments, the top end 112 includes one or more rounded edges or corners. In still other embodiments, the top end 112 does not include beveled edges.

In the illustrated embodiment, the bottom wall 140 of the end cap 100 comprises a flat bottom surface and a parallel, flat upper surface within the cavity 104. However, in other embodiments, the upper surface within the cavity 104 may not be parallel within the bottom surface. For example, in some embodiments, the bottom wall 140 comprises a wedge shape, and the side walls are configured to receive the end of the piece of lumber at an angle relative to the bottom surface such that, when the end cap 100 is placed on a flat surface, the lumber extends at an oblique angle relative to the flat surface. For example, in some embodiments, the end cap 100 could be used on a wooden structure with non-vertical legs, such as a saw horse. In that regard, the end cap 100 may comprise a wedge-shaped bottom wall 140, angled side walls, and/or other structural features to allow for use of the end cap 100 with wooden structures that have oblique legs. In some embodiments, the end cap 100 may be configured to receive a piece of lumber at 75° relative to normal, as opposed to 90°, which is the embodiment illustrated in FIGS. 1A-1C. However, other angles are also contemplated, both larger and smaller, including 80°, 70°, 60°, 45°, 30°, or any other suitable angle.

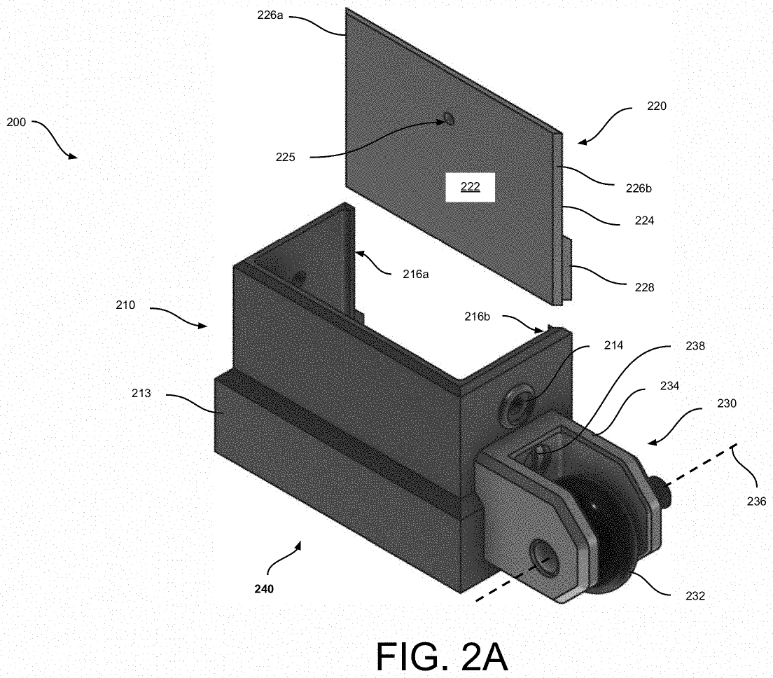

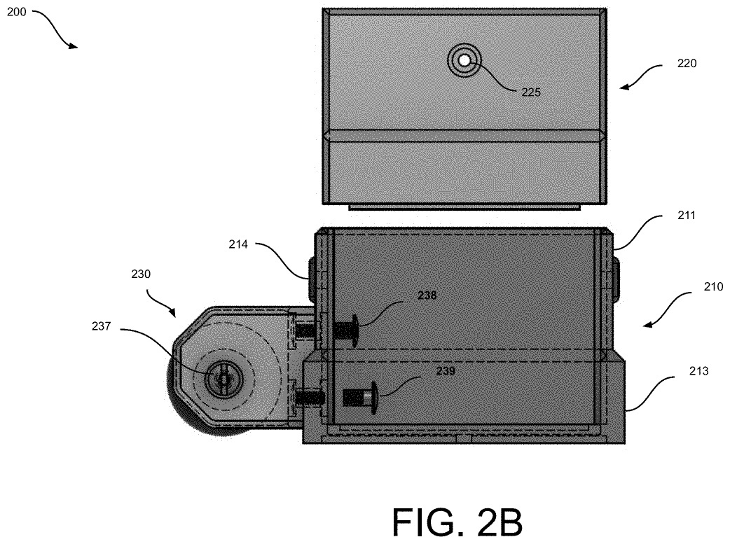

FIGS. 2A and 2B depict an end cap assembly 200, according to an embodiment of the present disclosure. In the illustrated embodiment, the end cap assembly 200 includes components similar to those described with respect to FIGS. 1A-1C, including an upper portion, a transition portion, a base portion, and securing holes 214. In the embodiment of FIGS. 2A and 2B, the end cap assembly 200 further comprises a removable side wall 220 sized, shaped, and structurally arranged to be removably coupled to a main body portion 210 of the end cap assembly. For situations when it is not possible to slide an entire end cap assembly 200 under the end of a leg, the removable side wall 220 allows the boot to be installed. For example, if a heavy shelf has been constructed out of 2×4 legs and it is not feasible to lift each leg several inches in order to install a one-piece end cap, the main body portion 210 of the end cap assembly 200 can be slid onto the leg horizontally which requires that the leg be lifted only as high as the thickness of the bottom wall of the main body portion 210, approximately ¼ inch, for example. The removable side wall 220 can then be slid on to give protection and aesthetic consistency to the leg. In the illustrated embodiment, the side wall portion 220 is sized, shaped and structurally arranged such that, when attached to the main body portion 210, the side wall portion 220 and main body portion 210 form a partial enclosure similar to the end cap 100 shown in FIGS. 1A-1C. For example, in some embodiments, the side wall portion 220 shown in FIGS. 2A and 2B comprises edges 226a, 226b configured to engage corresponding grooves 216a, 216b in the main body portion 210 such that the side wall portion 220 slides into place. In that regard, in the illustrated embodiment, the edges 226a, 226b of the side wall portion 220 and the grooves 216a, 216b of the main body portion 210 form a tongue and groove joint. In some embodiments, the edges 226a, 226b and grooves 216a, 216b are configured to create a water resistant seal or interface when the side wall portion 220 is coupled to the main body portion 210. With this configuration, the end cap assembly 200 may be coupled to an existing wood structure without needing to lift the structure high enough to clear the height of the end cap assembly 200. Rather, the end cap assembly 200 can be coupled to the structure by lifting the structure just high enough to clear the height or thickness of the bottom wall 240 of the end cap assembly 200. The side wall portion 220 includes an upper portion 224 having a first thickness and a lower portion 228 having a larger second thickness. The upper portion 224 and lower portion 228 are configured such that, when the side wall portion 220 is coupled to the main body portion 210, the outer profile of the side wall portion 220 matches the outer profile of the main body portion 210, including the base portion 213 and upper portion 211. Accordingly, the side wall portion 220 may also include a transition region configured to match the transition region around the main body portion 210. An inner surface 222 of the side wall portion 220 is flat, or substantially flat to match the inner surfaces of the main body portion 210. Further, the side wall portion 220 comprises or defines a securing hole 225 that can be used to secure the side wall portion 220 and main body portion 210 together when the assembly 200 is attached to an end of a piece of lumber. In that regard, when the main body portion 210 is attached to the piece of lumber and the side wall portion 220 is coupled to the main body portion 210, screws, nails, or other fasteners can be placed through the securing holes 225, 214, such that side wall portion 220 is fixedly secured to the main body portion 210 via the piece of lumber.

Other configurations for providing a removable sidewall portion 220 are also contemplated. For example, in some embodiments, the sidewall portion 220 is configured to couple to the main body portion 210 using a latch connection. In some embodiments, the sidewall portion 220 comprises grooves, and the main body portion 210 comprises edges.

End cap assembly 200 further comprises a roller 230 that can provide increased mobility to the surfaces to which the end cap assembly 200 is attached. For example, using the end cap assembly 200 shown in FIGS. 2A and 2B, a user can lift or tilt the roller such that the bottom 240 of the main body portion 210 is no longer contacting the floor, but the roller 230 contacts/continues to contact the floor, thereby allowing the user to roll the structure to a desired location, for example. The roller 230 includes a roller body or chassis 234, and a wheel 232 coupled to the roller body 234 such that the wheel rotates with respect to a roller axis 236. In an exemplary embodiment, the wheel 232 comprises a caster wheel and is coupled to the roller body 234 by an axel and/or a bearing. The roller 230 is configured to be coupled to the main body portion 210 of the assembly 200 using fasteners 238, 242, 244, positioned between respective holes in the roller body 234 and the main body portion 210. In the illustrated embodiment, each fastener comprises a screw (e.g., 238), and the head of each screw is positioned on the roller body 234 side of the assembly 200. On the opposing side, within a cavity of the main body portion 210, posts 242 and 244 are positioned through the holes. The posts 242 244 each comprise a threaded hollow interior portion configured to receive a respective screw (e.g., 238). Accordingly, in the illustrated embodiment, the roller 230 of the end cap assembly 200 is removable such that a user may couple the roller 230 to the main body portion 210 when the corresponding wood structure is intended to be mobile, or remove the roller 230 when mobility is not needed or desired. In other embodiments, the roller body 234 may be integral with the main body portion 210 of the end cap assembly 200. Further, in some embodiments, the side wall portion 220 may be integral with the main body portion 210 such that the side wall portion 220 is not removable. For example, in some embodiments, the main body portion 210, side wall portion 220, and roller body 234 form a single molded body. In some embodiments, the roller 230 may be attached to the main body portion 210 using fasteners other than posts and screws.

The roller body 234 includes an inner surface configured to oppose and/or engage the outer surface of the main body portion 210. In the illustrated embodiment, the inner surface of the roller body 234 matches the outer surface or profile of the main body portion, including the transition region and the base portion 213. The respective matching surfaces of the main body portion 210 and the roller body 234 may advantageously aid in the positioning and/or coupling of the roller body 234 and the main body portion 210. However, in other embodiments, the roller body 234 may comprise a flat inner surface configured to engage only one area or region of the main body portion, such as the base portion 213 or the upper portion 211.

In the illustrated embodiment, the roller 230 is coupled to the main body portion such that the bottom of the wheel 232 is coplanar, or substantially coplanar (i.e. +/−5 mm) with the bottom of the main body portion. Coupling the roller 230 to the main body portion 210 in this manner may reduce the amount of tipping required to engage the roller 230 with the floor to move the structure. In some embodiments, the roller 230 is coupled to the main body portion 210 such that the wheel 232 contacts the floor when the structure is at rest. In other embodiments, the roller 230 is coupled to the main body portion 210 such that the wheel 232 is positioned less than 1 cm from the floor when the structure is at rest. However, other structural arrangements are contemplated, including arrangements in which the wheel 232 is positioned higher or lower. In some embodiments, a caster wheel assembly may be attached to a side or bottom of the main body portion 210 to allow the wood structure to be rolled in any direction.

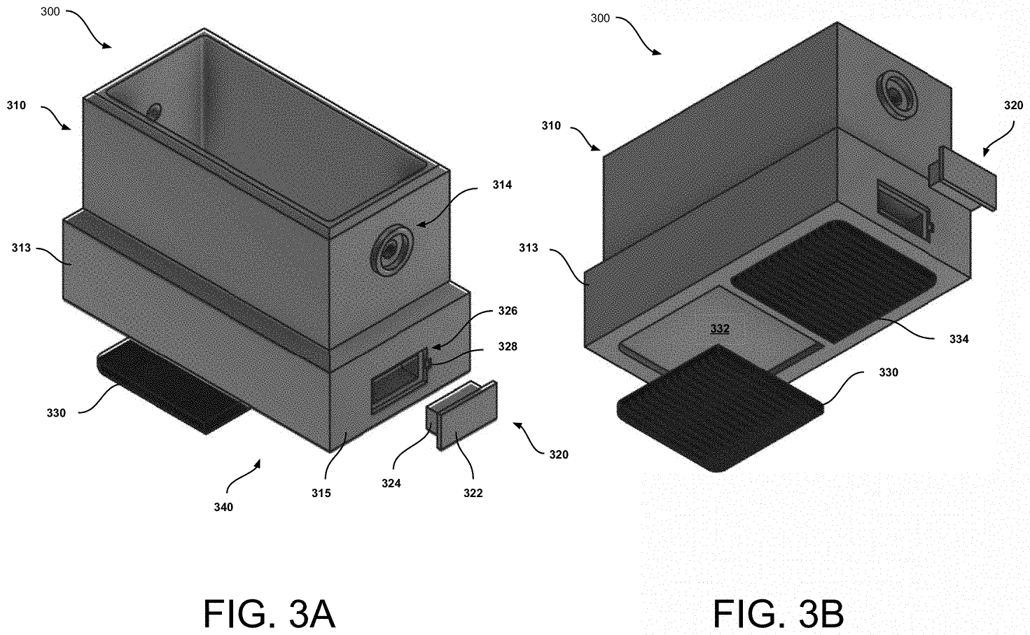

FIGS. 3A and 3B illustrate another embodiment of an end cap assembly 300. The end cap assembly 300 includes an end cap 310 and a shim plug 320. In some aspects, the end cap 310 may comprise many of the features of the end cap 100 shown in FIGS. 1A-1C, including a base portion 313, a securing hole 314, a cavity 340, a bottom wall 340, and other features. To aid in the leveling and removing of wobbles mentioned previously, an opening in one or more sides of the boot allows shimming material to be slid underneath the inserted leg to raise the stud inside of the boot to the desired height before driving the screws through the screw holes of the boot. In that regard, the embodiment of FIGS. 3A and 3B includes a shim hole 326 sized and shaped to receive a shim for positioning between the bottom of the cavity 340 and the bottom surface of a piece of lumber. In some embodiments, the shim hole 326 is sized, shaped, and structurally arranged to receive a conventional, off-the-shelf shim. In some embodiments, the shim hole 326 comprises a height of 5 mm and a width of 10 mm, such that the shim hole 326 is configured to receive a shim having a height of 5 mm or less and a width of 10 mm or less. However, the shim hole 326 may comprise any suitable height and/or width, both larger and smaller.

As mentioned above, in some instances, the legs of a wooden structure may not be even. Alternatively, or additionally, the surface on which the wooden structure stands may not be even. Accordingly, the end cap assembly 300 shown in FIGS. 3A and 3B allows for adjustment of the height of individual legs by placing shims of varying height through the shim hole 326. Once the shim(s) is/are in place, the shim plug 320 can be placed in the shim hole 326 to provide a seal. The shim plug 320 comprises a plug body 324 and a stopper portion 322. The plug body 324 is sized and shaped to be inserted into the shim hole 326, and the stopper portion 322 is sized and shaped to engage an outer surface of the shim hole 326. The shim plug 320 is structurally arranged such that a back surface of the stopper portion 320 is flush with the outer surface 315 of the end cap 310 to provide aesthetic consistency with the rest of the end cap assembly 300. The shim hole 326 includes a notch 328 in the side of the shim hole 326 that can be used to insert a tool to remove the shim plug 320. In some embodiments, the seal provided by the shim plug 320 is water resistant. In some embodiments, the shim plug 320 comprises the same material of the end cap 310. However, in other embodiments, the shim plug 320 comprises a different material than the end cap 310. For example, in some embodiments, the end cap 310 comprises a rigid plastic, such as nylon, Acrylonitrile butadiene styrene (ABS) plastic, polyvinyl, polyurethane, polyetheretherketone (PEEK), Delrun, or any other suitable plastic. The shim plug 320 may comprise an elastomeric material, such as rubber, silicone, etc. An elastomeric shim plug 320 may allow for a better seal between the shim plug 320 and the end cap 310. In some embodiments, the end cap assembly 300 does not include a shim plug 320.

In the illustrated embodiment, the end cap assembly further comprises grip pads 330, 334 configured to be positioned within rectangular recesses (e.g., 332) on an underside or bottom of the end cap assembly 300. The grip pads 330, 334 protrude past the bottom of the end cap 300 so that when significant weight is applied to the end cap, the grip pads 330, 334 are not squeezed entirely up into the recesses. The grip pads 330 may comprise separate pieces of material, such as a polymeric, elastomeric (e.g., rubber, silicone rubber), or any other suitable type of material, that are coupled within the recesses of the end cap assembly 300 via adhesives, heat welding, fasteners, etc. In some embodiments, the grip pads 330, 334 are molded in place. In some embodiments, the main body portion 310 and the grip pads 330, 334 form an integral body or structure. In some embodiments, the grip pads 330, 334 comprise a patterned surface, which may include ridges, divots, waves, or any other suitable textured surface. In some embodiments, the end cap assembly 330, 334 does not include grip pads, but a device and/or material configured to reduce the friction between the bottom of the end cap assembly 300 and the floor. For example, the end cap assembly 300 may include one or more rollers or caster wheel assemblies configured to be coupled to the recesses 332 of the end cap assembly 300. In some embodiments, the end cap 310 may include multiple individual components that, for example, are molded separately and coupled together either at the manufacturer or by the end user. In some embodiments, the wider base portion and slanted transition portion forms a first end cap body portion, and the narrower top portion comprises a separate second end cap body portion that slides into the first end cap body portion.

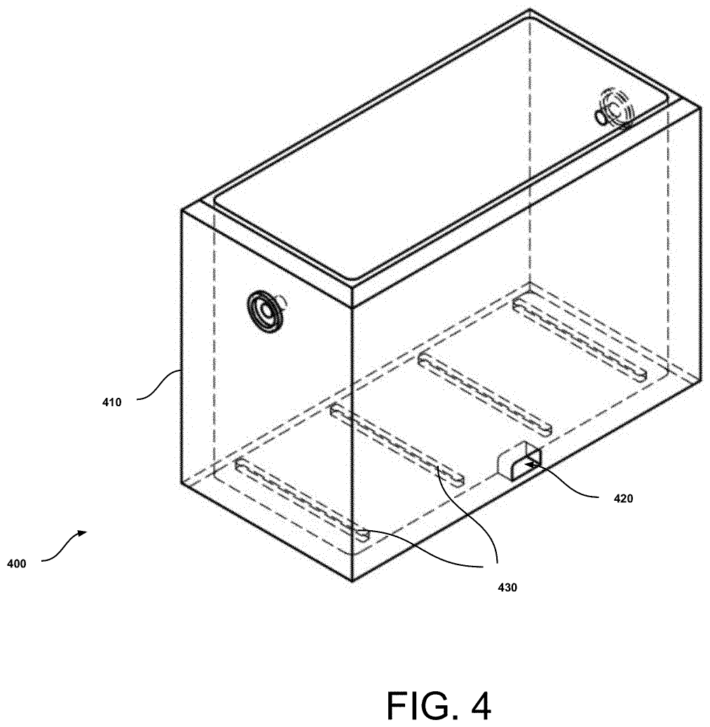

As shown in FIG. 4, in one embodiment, an end cap 400 includes a rectangular body 410 having consistent or substantially consistent outer surfaces and dimensions along a height of the body 410. The body 410 includes a weep hole 420 near the bottom of a lateral surface of the body 410. In the illustrated embodiment, the weep hole 420 is on the longer surface of the end cap 400. However, it will be understood that in other embodiments, the weep hole 420 may be on either or both of the shorter sides/surfaces of the end cap 400. In some embodiments, the weep hole 420 may be on both a short side/surface and a long side/surface of the end cap 400.

Further, the end cap 400 comprises a plurality of riser features 430 protruding from a bottom surface of the end cap body 410. The riser features 430 may elevate the stud within the end cap 400 so that a small amount of water that may enter into the end cap body 410 does not absorb into the end grain of the stud. The riser features 430 may comprise any suitable shape or pattern, including diagonal, curved, serpentine, radial, concentric, or any other suitable shape/pattern. As above, in some embodiments, end cap 400 may comprise separately-molded components that couple together. In such embodiments each component may comprise weep holes that align when coupled together.

Persons skilled in the art will recognize that the apparatus, systems, and methods described above can be modified in various ways. Accordingly, persons of ordinary skill in the art will appreciate that the embodiments encompassed by the present disclosure are not limited to the particular exemplary embodiments described above. In that regard, although illustrative embodiments have been shown and described, a wide range of modification, change, and substitution is contemplated in the foregoing disclosure. It is understood that such variations may be made to the foregoing without departing from the scope of the present disclosure. Accordingly, it is appropriate that the appended claims be construed broadly and in a manner consistent with the present disclosure.

What is claimed is:

1. An end cap for lumber products, comprising:
an integral body comprising a lower surface and at least three lateral walls defining an upwardly-opening cavity configured to receive an end of a rectangular piece of lumber, wherein the integral body comprises:
an upper portion comprising a first width and a first length;
a lower portion comprising a second width and a second length, wherein the first width is smaller than the second width and wherein the first length is smaller than the second length; and
a transition portion comprising a tapered surface positioned between the upper portion and the lower portion,
wherein a first lateral wall defines a first through-hole in the upper portion of the body extending from an exterior surface of the first lateral wall to an interior surface of the first lateral wall.

2. The end cap of claim 1, wherein a second lateral wall opposite the first lateral wall defines a second through-hole in the upper portion of the body extending from an exterior surface of the second lateral wall to an interior surface of the second lateral wall.

3. The end cap of claim 1, further comprising a high-friction pad positioned on the lower surface.

4. The end cap of claim 1, wherein the integral body comprises a molded construction formed of at least one of nylon, polyethylene, polyvinyl, polyetheretherketone (PEEK), or Acrylonitrile butadiene styrene (ABS).

5. The end cap of claim 1, further comprising a removable lateral wall portion configured to be removably positioned between a first lateral wall and a third lateral wall, wherein the removal lateral wall portion comprises lateral projections configured to engage respective lateral grooves in the integral body.

6. A footing configured to couple to an end of a piece of lumber, the footing comprising:
a cap portion comprising a plurality of walls defining a cavity configured to receive the end of the piece of lumber, wherein the cap portion comprises a lower section and an upper section, the upper section defining an opening of the cavity, and wherein the lower section comprises a first outer profile that is larger than a second outer profile of the upper section; and
a roller assembly attached to a first lateral wall of the cap portion, the roller assembly comprising:
a wheel;
an axel; and
a wheel housing coupled to the axel,
wherein the roller assembly is coupled to the cap portion such that the wheel is positioned above a bottom plane of the cap portion.

7. The footing of claim 6, wherein the roller assembly is separably attached to the first lateral wall of the cap portion, wherein the wheel housing comprises an inner surface configured to abut the lower section and the upper section of the cap portion.

8. The footing of claim 7, wherein the inner surface of the wheel housing defines a first through-hole and the first lateral wall defines a second through-hole, and wherein the roller assembly is separably attached to the first lateral wall via a fastener positioned through the first lateral wall and the inner surface.

9. The footing of claim 8, wherein the upper section of the first lateral wall defines a securing hole, and wherein the roller assembly is coupled to the first lateral wall such that access to the securing hole is unobstructed.

10. An end cap assembly, comprising:
a main body comprising:
a first lateral wall, a second lateral wall, a third lateral wall, and a bottom wall defining a cavity, wherein each of the first lateral wall, the second lateral wall, and the third lateral wall comprise an upper portion having a first thickness, a base portion having a larger second thickness, and a tapered transition portion positioned between the upper portion and the base portion and forming a transition in thickness between the base portion and the upper portion; and
a removable side wall configured to be coupled to the main body portion, wherein the removable side wall portion comprises an upper portion having the first thickness, a base portion having the second thickness, and a transition portion positioned between the base portion and the upper portion and forming a transition in thickness between the base portion and the upper portion,
wherein the main body and the removable side wall portion are configured to form a tongue and groove coupling such that, when the removable side wall is coupled to the main body, the end cap assembly comprises a symmetrical cross-section.
